(19) United States
(12) Patent Application Publication
(10) Pub. No.: US 2013/0046889 A1
(43) Pub. Date: Feb. 21, 2013

(54) METHODS AND APPARATUSES FOR SCHEDULING USERS IN WIRELESS NETWORKS

(71) Applicants: Antonia TULINO, Lincroft, NJ (US); Jonathan LING, North Brunswick, NJ (US)

(72) Inventors: Antonia TULINO, Lincroft, NJ (US); Jonathan LING, North Brunswick, NJ (US)

(73) Assignee: Alcatel-Lucent USA Inc., Murray Hill, NJ (US)

(21) Appl. No.: 13/209,656

(22) Filed: Aug. 15, 2011

(51) Int. Cl. G06F 15/173

(52) U.S. Cl. 709/225

(57) ABSTRACT

In a method for scheduling a set of active users for transmission in a wireless network, a plurality of scheduling metrics are calculated based on system state information for the wireless network, and the set of active users are scheduled for transmission according to the candidate transmission schedule corresponding to a maximum scheduling metric from among the calculated scheduling metrics. Each of the plurality of scheduling metrics corresponding to a candidate transmission schedule among a plurality of candidate transmission schedules.

### BACKGROUND OF THE INVENTION

An access point, such as a femto base station, typically covers a smaller geographic area or subscriber constituency than a conventional macro base station. In one example, a femto base station typically provides radio coverage in a geographical area such as a building or home, whereas a conventional macro base station provides radio coverage in a larger area such as an entire city or town. As a result, the radio frequency (RF) transmit power within these cells is discontinuous following variations in traffic loading.

Furthermore, ad-hoc placement of access points leads to some access points being placed too close to others, which results in relatively strong interference between user equipments (UEs).

Conventionally, frequency reuse is used to improve link signal-to-interference and noise ratios (SINRs) for users in macro-cellular networks. By reusing the same channel in geographically distant locations, SINR improves, but area spectral efficiency is usually reduced. With intelligent channel allocation algorithms, edge rates (the 5^{th} percentile of user rate cumulative distribution function (CDF)) are typically improved with higher reuse factors (e.g., greater than 1).

Fractional frequency reuse (FFR) improves edge rates by assigning the level of uses on a user specific basis. A basic FFR scheme includes an inner band and an outer band. The inner band is reused in all cells, whereas the outer band is reused every R cells. One can examine the rate for both bands, and place the user equipment in the band that provides the highest rate.

When using FFR, frequency allocation between the bands and the level of reuse must be determined in advance. That is, the scheme is static with regard to the users' locations and their traffic loading. Thus, load balancing techniques must be used in conjunction with conventional FFR schemes.

### SUMMARY OF THE INVENTION

Example embodiments provide methods for scheduling active users for transmission in a wireless network.

Methods according to at least some example embodiments utilize optimal fractional frequency reuse (FFR) patterns.

According to at least some example embodiments, optimal FFR is based on the evaluation of all combinations of transmission patterns; that is, communication that occurs one link at a time with little or no interference, or communication by a plurality of links simultaneously at a lower rate due to interference.

For a single carrier, a fractional frequency reuse (FFR) transmission pattern is a certain combination of (one or more) users, transmitting at fixed power at the same time (simultaneously or concurrently). The variables are the fractions of time (or time intervals) during which each transmission pattern is active. The problem has a convex formulation, and thus, the fraction of time during which each transmission pattern is active is determined by solving a convex optimization problem.

According to at least some example embodiments, for certain set of active transmitters and receivers, optimization is performed over all convex combinations of FFR patterns. More specifically, a scheduler determines a transmission schedule that maximizes a scheduling metric. In at least some example embodiments, all users are served, and no users are starved.

According to at least one example embodiment, the scheduler determines a transmission schedule for a set of active users using an optimized schedule proportional fair (OSPF) scheduling method. In this example, the scheduler determines the transmission schedule according to proportional fair (PF) criteria.

In another example embodiment, the scheduler determines the transmission schedule using a round robin with interference coordination (RR-IC) scheduling method. By using this algorithm, the scheduler coordinates interference between access points after a single active user is selected from among active users served by each access point via round-robin.

In still another example embodiment, the scheduler determines the transmission schedule using a variant of the RR-IC method, which is referred to as a first-come-first-serve with interference coordination (FCFS-IC) scheduling method. In this example, users' packets are served on a first-come-first-serve (FCFS) basis rather than being time division multiplexed with other users. In some cases, FCFS-IC may reduce packet delay.

The complexity of OSPF scheduling is exponential with regard to the total number of users, whereas RR-IC's complexity is exponential with regard to the number of active access points. While sometimes discussed with regard to a 3rd Generation Partnership Project Long-Term Evolution (3GPP LTE) network, a generic, high-level abstract air interface is assumed for the sake of this discussion. Example embodiments are applicable to many different wireless technologies including those discussed herein. A single carrier is also assumed, and users associated with the same access point are time multiplexed.

At least one example embodiment provides a method for scheduling a set of active users for transmission in a wireless network. According to at least this example embodiment, the method includes: calculating, at an access point management system, a plurality of scheduling metrics based on system state information for the wireless network, each of the plurality of scheduling metrics corresponding to a candidate transmission schedule among a plurality of candidate transmission schedules; and scheduling the set of active users for transmission according to the candidate transmission schedule corresponding to a maximum scheduling metric from among the calculated scheduling metrics.

At least one other example embodiment provides an access point management system for scheduling a set of active users for transmission in a wireless network. The access point management system includes a scheduler. The scheduler is configured to calculate a plurality of scheduling metrics based on system state information for the wireless network, each of the plurality of scheduling metrics corresponding to a candidate transmission schedule among a plurality of candidate transmission schedules. The scheduler is also configured to schedule the set of active users for transmission according to the candidate transmission schedule corresponding to a maximum scheduling metric from among the calculated scheduling metrics.

At least one other example embodiment provides a method for scheduling active users for transmission in a wireless network. According to at least this example embodiment, the method includes: determining, at an access point management system, a transmission schedule for the active users by optimizing a scheduling metric for the active users, the transmission schedule being indicative of a time interval during which each of the active users is scheduled to transmit; and scheduling the active users for transmission according to the determined transmission schedule.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a portion of a telecommunications system in which illustrative embodiments may be implemented;

FIG. 2 is a flow chart illustrating a method for scheduling active users for transmission in a wireless network according to an example embodiment;

FIG. 3 is a flow chart illustrating an example embodiment of step S202 in FIG. 2; and

FIG. 4 illustrates an example propagation matrix.

### DETAILED DESCRIPTION OF THE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, may be embodied in many alternate forms and should not be construed as limited to only the embodiments set forth herein.

Accordingly, while example embodiments are capable of various modifications and alternative fauns, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., access point management systems, femto management systems, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the ter in “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will pedal in the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

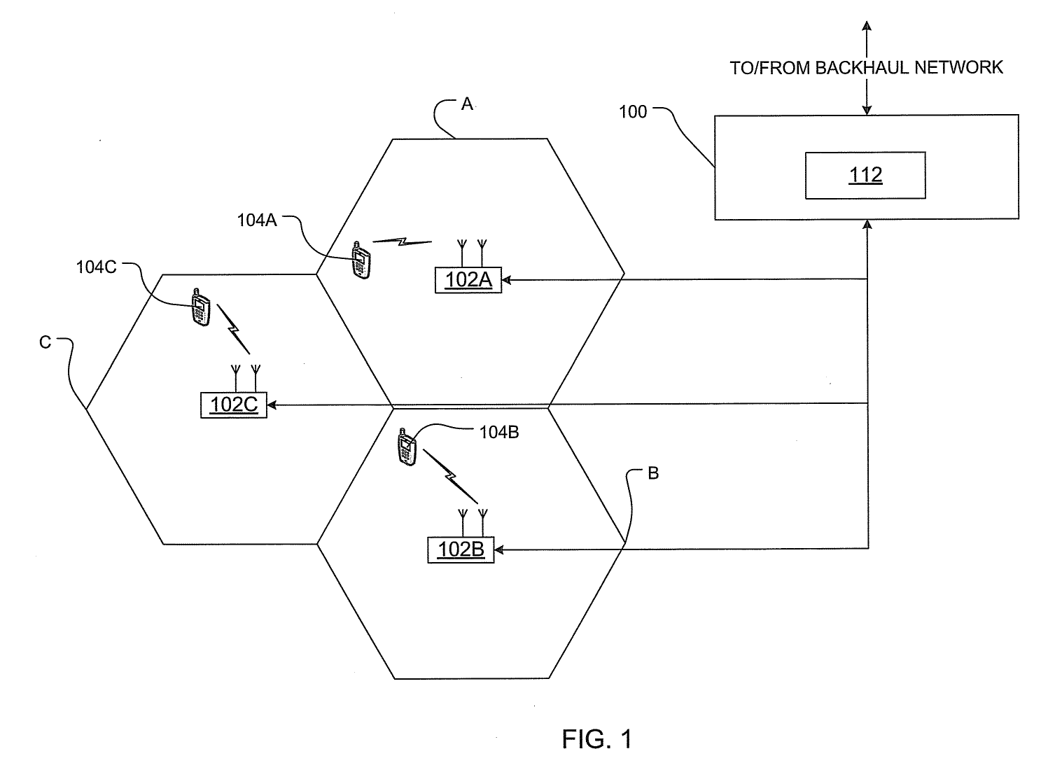

FIG. 1 illustrates a portion of a telecommunications system in which example embodiments may be implemented. The portion of the telecommunications system is a radio access network (RAN) including access points 102A, 102B and 102C. The access points 102A, 102B and 102C provide radio frequency (RF) coverage over a corresponding geographical area. These respective geographical coverage areas are referred to as cells A, B and C in FIG. 1. As used herein, the phrase “access point” may refer to a “femto base station,” “pico base station,” “micro base station,” or the like.

Still referring to FIG. 1, an access point management system (APMS) 100 is connected to each of a plurality of access points 102A through 102C via one or more packet and/or circuit switched networks (e.g., one or more Internet Protocol (IP) networks or the like). The APMS 100 includes a scheduler 112, which will be described in more detail below.

Although FIG. 1 shows the APMS 100 as separately connected to each of the access points 102A through 102C, the APMS 100 may be implemented at one of the access points 102A through 102C, and connected to the others of the access points.

The APMS 100 is analogous to and has the same well-known functionality as a RAN control node in a macro cellular system and a femto management system (FMS) in a femto cellular system. One aspect of this well-known functionality is scheduling, in which users are scheduled for transmission by allocating wireless resources among the plurality of users. In the example shown in FIG. 1, scheduling is performed by the scheduler 112 at the APMS 100. Methods for scheduling active users for transmission at the scheduler 112 will be described in more detail below.

Because other functionality of RAN control nodes and the APMS is well-known, a detailed discussion is omitted.

As discussed herein, node 100 is termed “APMS,” elements A through C are termed cells, and elements 102A through 102C are termed access points. However, it should be understood that the term radio network controller and base station also encompasses nodes having similar functionality for other types of RANs.

Example embodiments may be utilized in conjunction with RANs such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TLA IS-95; Worldwide Interoperability for Microwave Access (WiMAX); ultra mobile broadband (UMB); and 3^{rd} Generation Partnership Project Long Term Evolution (3GPP LTE).

Referring still to FIG. 1, as is well-known, user equipments 104A through 104C communicate with one or more of access points 102A through 102C over an air interface. The user equipments 104A through 104C may be, for example, mobile telephones (“cellular” telephones), portable computers, pocket computers, hand-held computers, personal digital assistants (PDAs), car-mounted mobile devices or the like, which communicate voice and/or data with the RAN. Throughout this disclosure, the term “users,” “user equipments” and “UEs” may be used interchangeably.

For the sake of example, FIG. 1 shows only a single APMS 100, three access points 102A, 102B, 102C and three users 104A, 104B and 104C. However, it will be understood that RANs may include any number of APMSs and/or access points, which serve any number of user equipments.

Example embodiments provide methods for scheduling active users for transmission in a wireless network. Example embodiments also provide schedulers configured to schedule active users for transmission in a wireless network.

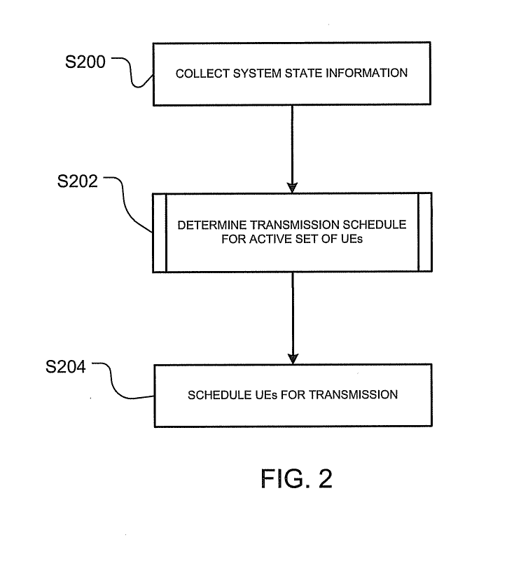

FIG. 2 is a flow chart illustrating a method for scheduling active users for transmission in a wireless network. The method shown in FIG. 2 will be described with regard to the RAN shown in FIG. 1.

As discussed herein, a set of active users refers to users having data to transmit (data queued for transmission) on the uplink (from user to access point) or receive on the downlink (from access point to user). In the example shown in FIG. 1, the set of active users includes the three users 104A, 104B and 104C.

According to at least some other example embodiments, the set of active users may include users selected from sets of users being served by each of a plurality access points. In one example, the users may be selected according to one of a round robin and a first-come-first-serve method.

Referring to FIG. 2, at step S200, the APMS 100 collects system state information for the RAN. In one example, the APMS 100 collects all downlink receive power information at the users 104A through 104C. The downlink receive power information includes information sufficient to determine/calculate the signal-to-interference and noise ratio (SINR) for each user. The downlink receive power information may include the receive signal power at each user. The downlink receive power information is collected through well-known control signaling.

At step S202, the scheduler 112 determines a transmission schedule for the set of active users based on the collected system state information. According to at least one example embodiment, the transmission schedule is in the form of a column vector α, an example of which is shown below in Equation (1).

α={α₁α₂α₃ . . . αₘ} (1)

In Equation (1), each αₖ, where kε{1, 2, 3, . . . , m}, represents a fraction of time (time fraction or time interval) during which a given fractional frequency reuse transmission pattern is active. Thus, the transmission schedule a designates a combination of transmission patterns to be used in scheduling the active users for transmission in the network. The combination of transmission patterns may include one or more transmission patterns time multiplexed with one another.

As mentioned above, a fractional frequency reuse (FFR) transmission pattern is a certain combination of (one or more) users transmitting at fixed power at the same time (simultaneously or concurrently). When a transmission pattern is active, the particular combination of users corresponding to the transmission pattern is scheduled to transmit.

Also in Equation (1), m=2^{N}−1, and N is the number of active users in the set of active users.

With regard to FIG. 1, if the set of active users includes users 104A, 104B and 104C, then N is 3, m is 7 and the transmission schedule α is given by Equation (2) shown below.

α={α₁α₂α₃α₄α₅α₆α₇} (2)

Still referring to step S202 in FIG. 2, according to at least one example embodiment, the scheduler 112 determines the transmission schedule a for the set of active users using convex optimization. More specifically, for example, the scheduler 112 determines the transmission schedule a by solving a convex optimization problem, such as the convex optimization problem (A) shown below. By solving this optimization problem, the scheduler 112 optimizes spectral reuse within the network.

$$maximize \text{:} {\sum }_{i = 1}^{N} log ( {R}_{i} ) \\ subject to \text{:} {\sum }_{k} {α}_{k} = 1 \\ 0 \leq {α}_{k} < 1 \\ R = V α \qquad ( A )$$

In optimization problem (A),

$${\sum }_{i = 1}^{N} log ( {R}_{i} )$$

is a scheduling metric, and N is the number of users in the active set of users.

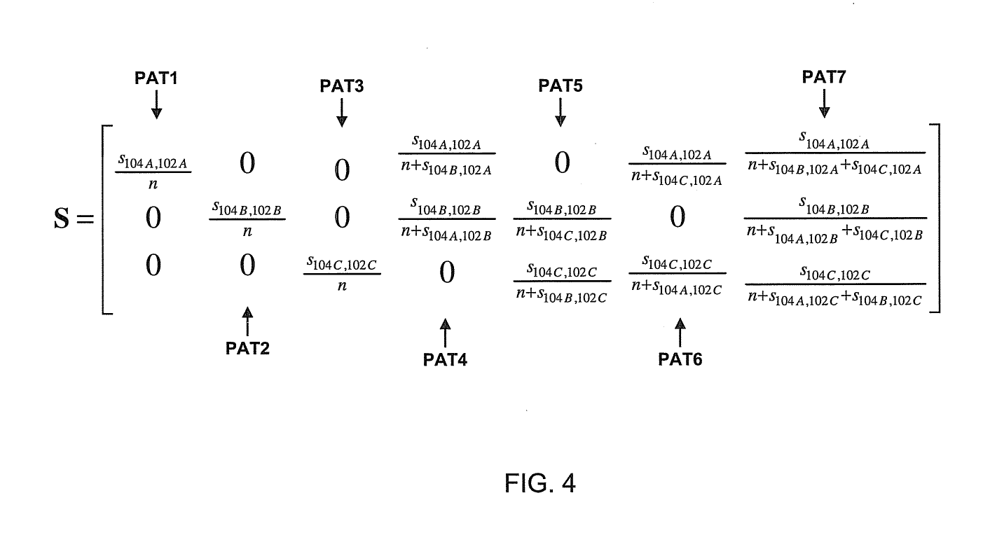

The matrix V (referred to herein as first transmission rate matrix V) is an N by 2^{N}−1 matrix determined based on a corresponding propagation matrix S, an example of which is shown in FIG. 4. More specifically, for example, the first transmission rate matrix V is determined through 1-to-1 mapping with a corresponding propagation matrix S.

As shown in FIG. 4, each column of the propagation matrix S includes receive signal-to-interference and noise ratios (SINRs) for each user when a corresponding one of seven transmission patterns PAT1 through PAT7 is active. Moreover, in FIG. 4, s_{i,j} represents the signal power from user to access point, i={104A, 104B, 104C}, and j={102A, 102B, 102C}.

In more detail, s_{104A,102A} is the signal power from user 104A to access point 102A, s_{104B,102A} is the signal power from user 104B to access point 102A, and so on. The additive white Gaussian noise (AWGN) from the receiver and other sources is represented by n.

Still referring to FIG. 4, the highest individual transmission rates with the lowest spectral reuse are obtained when one of transmission patterns PAT1, PAT2 and PAT3 are active for a given time interval. Transmission patterns PAT4 through PAT7 yield lower individual rates, but higher spectral reuse because more than one user is scheduled to transmit simultaneously during a given time interval.

Returning to the first transmission rate matrix V in optimization problem (A), the columns of the first transmission rate matrix V contain transmission rates when each of the transmission patterns PAT1 through PAT7 are active. The rates in the first transmission rate matrix V are modeled as continuous functions determined by interpolating the SINR-to-rate mapping, which is well-known and not discussed herein in detail. The scheduler 112 receives regular (e.g., periodic) measurements of the signal and interference powers from each receiver, and thus, is able to determine the rates for each transmission pattern in the first transmission rate matrix V using well-known methods.

One example of the first transmission rate matrix V is shown below in Equation (3).

$$V = [ \begin{matrix}{V}_{104 A , PAT 1} & 0 & 0 & {V}_{104 A , PAT 4} & 0 & {V}_{104 A , PAT 6} & {V}_{104 A , PAT 7} \\ 0 & {V}_{104 B , PAT 2} & 0 & {V}_{104 B , PAT 4} & {V}_{104 B , PAT 5} & & {V}_{104 B , PAT 7} \\ 0 & 0 & {V}_{104 C , PAT 3} & 0 & {V}_{104 C , PAT 5} & {V}_{104 C , PAT 6} & {V}_{104 C , PAT 7}\end{matrix} ] \qquad ( 3 )$$

The first transmission rate matrix V in Equation (3) corresponds to the propagation matrix S shown in FIG. 4. In this example, the transmission rate V_{104A,PAT1} is the transmission rate for the user 104A when the first transmission pattern PAT1 is active. Similarly, the rates V_{104B,PAT5} and V_{104C,PAT5} are the transmission rates for users 104B and 104C, respectively, when the fifth transmission pattern PAT5 is active.

Still referring to optimization problem (A), each Rᵢ is a transmission rate in a set of transmission rates for active users when a particular transmission pattern is active. Each Rᵢ is an element of a second transmission rate matrix R, which includes a set of transmission rates for the active users. In this example, the second transmission rate matrix R is determined by performing matrix multiplication between the transmission schedule (column vector) α and the first transmission rate matrix V. Thus, each second transmission rate matrix R is calculated based on the first transmission rate matrix V and a transmission schedule (column vector) α for the active users.

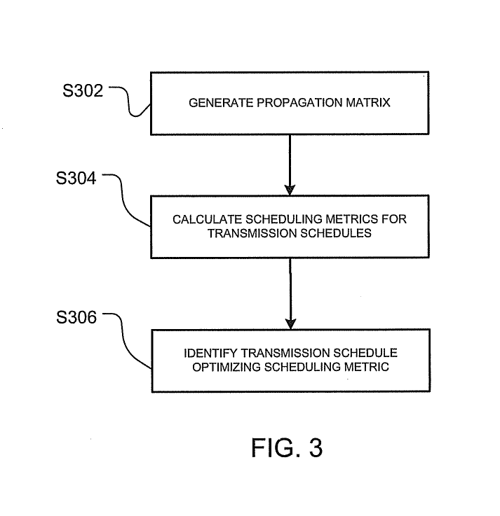

FIG. 3 is a flow chart illustrating a more detailed example of the operations performed at step S202 in FIG. 2.

Referring to FIG. 3, at S302, the scheduler 112 generates the above-described propagation matrix S based on the system state information obtained at step S200.

At step S304, the scheduler 112 calculates a scheduling metric

$${\sum }_{i = 1}^{N} log ( {R}_{i} )$$

for each candidate transmission schedule. Each candidate transmission schedule is a column vector α including values α₁ through αₘ. The values of each αₖ for each transmission schedule α are selected from values between 0 and 1, subject to the constraints of the optimization problem, and at step increments of, for example, about 0.1. The step increments may be selected according to design and/or communication protocol.

Returning to FIG. 3, at step S306, the scheduler 112 identifies the maximum scheduling metric from among the calculated scheduling metrics. The scheduler 112 may identify the maximum scheduling metric by comparing the calculated scheduling metrics. The scheduler 112 then selects the transmission schedule corresponding to the maximum scheduling metric among the calculated scheduling metrics.

Referring back now to FIG. 2, at step S204, the scheduler 102 schedules the users 104A, 104B and 104C for transmission based on the transmission schedule α. This scheduling is performed using well-known methods according to the determined transmission schedule. The active users then transmit data using to well known methods according to the scheduling by the scheduler 112.

Example embodiments utilize proportional fairness, which requires that all active users be served. So, the set of transmission patterns whose time fractions are non-zero must include all users in the set of active users. That is, the transmission patterns are combined such that each user in the active set of users is served during, for example, a transmission time interval (TTI).

According to at least some example embodiments, proportional fairness is satisfied for each column vector α generated by the scheduler 112. In the case of OSPF, proportional fairness is satisfied over all users.

For RR-IC, proportional fairness applies to the set of selected users, while RR ensures fairness over all users in the set of active users. In this example, the scheduling metric is maximized after a single active user is selected using a round robin method. Referring back to FIG. 1, for example, the scheduler 112 selects user 104A, and then determines a transmission schedule that maximizes the scheduling metric given that user 104A is scheduled to transmit during the TTI.

RR-IC may be used when more than one user is attached to each eNodeB. In this example embodiment, a single user is selected from each eNodeB via RR, and then the above-described algorithm is applied. As is known, round robin lists all users in order (at each eNodeB), and then the users are served sequentially. Thus, in at least one example embodiment, the set of active users may include a user selected from the plurality of users attached to each eNodeB. The above-described algorithm is then applied to the selected active users.

An FCFS-IC method, according to at least some example embodiments, is performed in a manner similar to the RR-IC method, except that the user is initially selected (prior to maximizing the scheduling rate metric) on a first-come-first-serve basis, rather than a round robin basis.

Each user has an associated queue, which holds the data at the eNodeB to be transmitted to the user on the downlink. These queues may be served in various ways including round robin and first-come-first-serve.

Transmission schedules discussed herein may be maintained until at least one transmission queue is drained or a new packet arrives. So, the amount of time covered by the transmission schedule is variable. If a transmission queue is emptied, the completion time is assumed to be the best possible, that is, the scheduler immediately serves this user. However, arrivals are calculated from the end of the scheduling period. In RR-IC a schedule is kept if the users remain the same.

The invention being thus described, it will be obvious that the same, may be varied in many ways. Such variations are not to be regarded as a departure from the invention, and all such modifications are intended to be included within the scope of the invention.

We claim:

1. A method for scheduling a set of active users for transmission in a wireless network, the method comprising:
calculating, at an access point management system, a plurality of scheduling metrics based on system state information for the wireless network, each of the plurality of scheduling metrics corresponding to a candidate transmission schedule among a plurality of candidate transmission schedules;
scheduling the set of active users for transmission according to the candidate transmission schedule corresponding to a maximum scheduling metric from among the plurality of calculated scheduling metrics.

2. The method of claim 1, further comprising:
selecting the candidate transmission schedule corresponding to the maximum scheduling metric from among the plurality of calculated scheduling metrics; and wherein
the scheduling step schedules the set of active users for transmission according to the selected candidate transmission schedule.

3. The method of claim 1, wherein the calculating step comprises:
generating a propagation matrix based on the system state information, the propagation matrix including signal-to-interference and noise ratios for the set of active users; and wherein
the calculating step calculates the plurality of scheduling metrics based on the generated propagation matrix.

4. The method of claim 1, further comprising:
collecting the system state information for the wireless network at the access point management system.

5. The method of claim 4, wherein the calculating step comprises:
generating a propagation matrix based on the collected system state information, the propagation matrix including signal-to-interference and noise ratios for the set of active users; and wherein
the plurality of scheduling metrics are calculated based on the generated propagation matrix.

6. The method of claim 5, wherein the calculating step further comprises:
generating a first transmission rate matrix based on the generated propagation matrix; and wherein
the plurality of scheduling metrics are calculated based on the generated first transmission rate matrix.

7. The method of claim 6, wherein the calculating step further comprises:
generating a second transmission rate matrix corresponding to each of the plurality of candidate transmission schedules, each second transmission rate matrix including a plurality of transmission rates for the set of active users; and wherein
each of the plurality of scheduling metrics is calculated based on a corresponding one of the second transmission rate matrices.

8. The method of claim 1, wherein the calculating step comprises:
generating a first transmission rate matrix based on the system state information; and wherein
the plurality of scheduling metrics are calculated based on the generated first transmission rate matrix.

9. The method of claim 8, wherein the calculating step further comprises:
generating a second transmission rate matrix corresponding to each of the plurality of candidate transmission schedules, each second transmission rate matrix including a plurality of transmission rates for the set of active users; and wherein
each of the plurality of scheduling metrics is calculated based on a corresponding one of the second transmission rate matrices.

10. The method of claim 1, wherein the wireless network includes a plurality of access points, each of the plurality of access points serving a plurality users, the method further comprising:
selecting the set of active users from among the plurality of users served by each access point.

11. The method of claim 10, wherein the set of active users is selected according to a round robin with interference coordination method.

12. The method of claim 10, wherein the set of active users is selected according to a first-come-first-serve with interference coordination method.

13. An access point management system for scheduling a set of active users for transmission in a wireless network, the access point management system comprising:
a scheduler configured to calculate a plurality of scheduling metrics based on system state information for the wireless network, each of the plurality of scheduling metrics corresponding to a candidate transmission schedule among a plurality of candidate transmission schedules, the scheduler being further configured to schedule the set of active users for transmission according to the candidate transmission schedule corresponding to a maximum scheduling metric from among the plurality of calculated scheduling metrics.

14. The access point management system of claim 13, wherein the scheduler is further configured to select the candidate transmission schedule corresponding to the maximum scheduling metric from among the plurality of calculated scheduling metrics, and to schedule the set of active users for transmission according to the selected candidate transmission schedule.

15. The access point management system of claim 13, wherein the scheduler is configured to generate a propagation matrix based on the system state information, the propagation matrix including signal-to-interference and noise ratios for the set of active users, and to calculate the plurality of scheduling metrics based on the generated propagation matrix.

16. The access point management system of claim 15, wherein the scheduler is further configured to generate a first transmission rate matrix based on the generated propagation matrix, and to calculate the plurality of scheduling metrics based on the generated first transmission rate matrix.

17. The access point management system of claim 16, wherein the scheduler is further configured to generate a second transmission rate matrix corresponding to each of the plurality of candidate transmission schedules, each second transmission rate matrix including a plurality of transmission rates for the set of active users, and to calculate the plurality of scheduling metrics based on a corresponding one of the second transmission rate matrices.

18. The access point management system of claim 13, wherein the wireless network includes a plurality of access points, and each access point serves a plurality users, the scheduler being further configured to select the set of active users from among the plurality of users served by each access point.

19. The access point management system of claim 18, wherein the set of active users is selected according to one of a round robin and a first-come-first-serve method.

20. A method for scheduling active users for transmission in a wireless network, the method comprising:
determining, at an access point management system, a transmission schedule for the active users by optimizing a scheduling metric for the active users, the transmission schedule being indicative of a time interval during which each of the active users is scheduled to transmit;
scheduling the active users for transmission according to the determined transmission schedule.
